(19) United States
(12) Patent Application Publication
(10) Pub. No.: US 2018/0131976 A1
(43) Pub. Date: May 10, 2018

(54) SERIALIZABLE VISUALLY UNOBTRUSIVE SCANNABLE VIDEO CODES

(71) Applicant: Sasha Zabelin, Berkeley, CA (US)

(72) Inventor: Sasha Zabelin, Berkeley, CA (US)

(21) Appl. No.: 15/730,725

(22) Filed: Oct. 11, 2017

Related U.S. Application Data
(63) Continuation-in-part of application No. 62/406,863, filed on Oct. 11, 2016.

(51) Int. Cl. H04N 21/234; H04N 21/858; H04N 21/81; H04N 21/845; H04N 21/431

(52) U.S. Cl. CPC H04N 21/23424; H04N 21/8586; H04N 21/812; G06K 19/06037; H04N 21/8456; H04N 21/4316; H04N 21/8153

(57) ABSTRACT

Systems, devices and methods are described for providing parallel content for a video. A database or collection of informational content is keyed to particular time segments of a video. An encoder generates links to the parallel content. Links are encoded into a series of visible video codes. Each visible video code is adapted to a respective frame of the video in at least one of hue, transparency and position. The visible video code may be a QR code or other machine-readable code. A visible video code provides a link to metadata, informational content, secondary content or other content associated with or about the primary video in which the visible video code is presented. Content is served to a secondary screen based at least on the visible video code and, alternatively, based on additional information available from a secondary device used to scan and interpret the visible video code in the primary video.

### CROSS REFERENCE TO RELATED APPLICATION

This patent application claims priority to U.S. Patent Application Ser. No. 62/406,863 filed on Oct. 11, 2016 titled “Visually Unobtrusive Scannable Video Codes,” the entirety of which are incorporated by reference herein.

### BACKGROUND

### Field

The present disclosure is generally related to including visible, machine-readable codes in a digital video by modifying the video based on the machine-readable codes.

### Description of Related Art

Advances in video technology have resulted in an ever increasing amount of video. The video is available on large and small screens. Advertising sometimes comes along with video. Commercial advertising has typically taken the form of still images and video interspersed between the actual produced video segments. Modern variations of commercials and modern advertising has allowed for clickable overlays. These overlays are embedded or enabled with links. However, while video advertising has enabled monetization of video, advertising and overlays of commercials are highly irritating and a nuisance to most viewers. Further, the overlays are not particularly targeted to the viewer and certainly not related to particular scenes or content of the video. Conventional advertising involves the push of stale information to viewers. Modern video consumers expect better ways to interact with video and expect the ability to interact with video in real time. To date, this is not possible.

Further, people increasingly want to interact with video of others, and react to and participate in social media with respect to the ever-increasing amount of available video. Video comes in many forms from recorded and edited video episodes of television and movies from studios to user-generated and user-shared (uploaded) video and to live-streamed video. Much of the video is consumed in a streaming format. Further, video comes in many file formats—encoded with one of various encoding algorithms—and in one of many possible file containers. Further, video is consumed on various types and sizes of displays and on a variety of platforms (e.g., hardware and operating system combinations) including in a web browser.

Generally, video consumers tune to or accept one stream at a time. In some conventional video broadcasts, there is an ability to receive and display multiple videos simultaneously such as by displaying a picture-in-picture (“PIP”) video. However, this is the exception rather than the rule. Even more rare is a display of information in the PIP video.

A chyron or lower third has been used for years to overlay primarily text-based information on top of an underlying video asset. Such composite videos are distracting to a typical media consumer because the overlays obscure a significant portion of the underlying image or video.

Conventional quick response (“QR”) codes and other machine-readable encodings can include information encoded therein, but are rarely seen in conventional video and video streams. While machine-readable codes and human readable codes can be overlaid on or composited with another image, the result is less than perfect and often obscures the underlying asset. For example, a single bright black and white QR code may be overlaid on top of an advertisement image to allow for a viewer to decode the QR code. For a modern audience, this type of composite has been very unsuccessful in terms of market adoption as an objective measure of success.

Further, when shown as part of a video, QR code acquisition and decoding are often impracticable because by the time a person or viewer is aware of a particular, static QR code, the viewer is not able to locate a smartphone or other device and then activate the device in time to capture and decode the QR code. Display of a QR code in such circumstances is effectively pausing of the advancement of the video and providing a commercial break for audience members to capture and decode the QR code. If a QR code is shown as part of an on-going, running or live video stream, a displayed QR code is displayed only for a short time and then is gone from an electronic display before a user is able to point a device at the electronic display and before the user can activate image capture and image scanning operations. Accordingly, there is a deficiency in the known art in terms of making QR codes and machine-readable codes available to viewers of video. Substantial opportunity exists to improve connection and interaction between video viewers, video producers, and video providers.

### SUMMARY

According to an illustrative aspect, a system provides parallel content for a video. The system could comprise a database or collection of informational content keyed to particular time segments of a video stream, wherein time segments include at least one frame of the video. The informational content can take any form including text, audio, video or other format. Links are generated to the informational content. While link is referred to herein, a link can mean a hyperlink such as transmitted over conventional HTTP-style mechanisms, or a link can be any mechanism to connect a second device to a first device through a visual interpretation as described more fully herein.

The links are converted into a series of visible video codes. Each visible video code is adapted and added to a respective frame the component. A visible video code is adapted by adjusting at least one visible aspect of the visible video code. Each visible video code is merged with or added to one or more respective frames of the video. Based on the particular format or encoding of the video, the visible video code may be added to the pixels of the respective raster-based images or frames of the video, or may be added as a layer or track in the video container that encapsulates the video. Preferably, the adapting or blending is done such that there is a visible machine-readable code included in a video, but that the presence of the visible video code is not obtrusive or distracting to a majority of a target audience for a video.

Such visible video codes may be used in commercial video screenings of movies shown in a theatre or on a television, computer display or tablet of a user. While the visible video codes are preferably used or usable while a video or video stream is running, the visible video codes may be used in the scenario where a user has the ability to pause the video and scan the code. For example, the visible video codes may be used during a live televised event (e.g., a concert, a political debate, a scientific conference presentation, a news broadcast). The visible video codes may also be used in or associated with a pre-recorded video such as a film studio movie, a game play capture, and so forth.

Each visible video code may be comprised of a two dimensional raster-based image. Each visible video code may include a time element for identifying a time or particular segment in a runtime of the video. Preferably, each visible video code includes modifying an aspect of the visible video code such as a transparency value or hue value. The visible video code may take the form of a QR code, a UPC-style bar code, or other machine-readable code. Alternatively, the visible video code may take the form of a human-readable code such as a link shortener for easy recollection when using the link. An area of the visible video code is placed in a region that is less than half of the video, and preferably in an area that is much less than half of the video.

According to an illustrative aspect, a system, a device, and a method are provided to generate composited video that includes machine- or human-readable codes or patterns. An initial code or pattern is changed on a second-by-second or other time-based step for a target video. Each second or other time unit of video is correlated or connected to a respective code or pattern. It is thereby possible to track when during play of a video that the code was scanned.

In order to make a video composited with a set of codes or patterns, the method first includes generating the codes or patterns. Next a processor type is chosen. For example, one of a central processing unit (CPU), a graphics processing unit (GPU), a field-programmable gate array (FPGA) or even a custom integrated circuit (ASIC) is chosen for compositing and/or processing of the source video based on the set of codes. The next step of the method includes choosing an algorithm for compositing, an algorithm that is available for the selected processor type. According to a first example where the starting code or codes are black and white, a simple algorithm is selected such as for each pixel in the original image, the simple algorithm iterates through pixels beneath the to-be-embedded code when processing the code. Where the code pixel is ordinarily black, the pixel brightness in the target video is decreased a pre-determined amount. Where the code pixel is ordinarily white, the pixel brightness in the target video is increased a pre-determined amount.

According to another illustrative aspect, brightness of code/image/video pixels can be shifted in one of multiple ways. According to a first way, a simple brightness color matrix is used to select and then increase or decrease R, G and B component values uniformly. According to a second way, an HSL (hue, saturation, and lightness or luminosity) or HSB (hue, saturation, and brightness) color transformation is performed whereby RGB values of code/image/video pixels are temporarily transformed into an HSL or HSB space, the luminosity or brightness values adjusted, and then the color space values are transformed back into the RGB space.

According to a third way, a brightness can be adjusted in a more complex way. In this third way, brightness of each pixel of the composited code/image/video is shifted a fixed, pre-determined amount and then an evaluation-feedback loop is performed whereby a brightness of composited code/image/video pixels is adjusted and a brightness contrast between composited code/image/video pixels and non-composited code/image/video pixels is evaluated. If the brightness contrast is not enough to have a code be adequately machine-readable, a further brightness change (e.g., fixed-size step) to each code/image/video pixel is performed and the brightness contrast is evaluated at an overall code-reading level for each frame. The goal for the third way is for just enough contrast to be evident for the purpose of machine-readability for each frame of the composited video, but to maximize blending (minimize of contrast) for the purpose of viewing by human observers. In these three ways, brightness of pixels are shifted for the code composited into frames of a source video.

According to another illustrative and optional aspect, a feedback loop adjusts (e.g., increases, decreases), in a variable step-size fashion, the brightness contrast between the code and non-code pixels, pixel by pixel, and then the completed, composited code/image/video is scanned by a code detector. Depending on an amount of difference, a step size is chosen and the feedback loop is adjusted, the code/image/video newly composited, and then the code tested for machine-readable accuracy. The detector determines whether a sufficient level of reading accuracy is met or exceeded. If so, the feedback loop is exited and the final video is generated by combining composited video frames. Otherwise, the loop is repeated until a sufficient level of accuracy is met or exceeded. This process is repeated on a frame by frame basis for an entire source video.

According to an alternative aspect, instead of a feedback loop that adjusts the brightness contrast based on a stepped new value for luminance, a luminance value of another pixel in the source frame is selected for the pixels of the code. The luminance values of the code are adjusted such as to the luminance value of the another pixel in the source frame. The code/image/video is composited and the code (e.g., frame of video) is tested for machine-readable accuracy. The luminance adjustment to the pixels of the code during the feedback loop is repeated if the accuracy level is not met or exceeded. In this alternative adjustment scheme, the luminance of the pixels of the code are adjusted to a value that is already associated with the frame of the video.

According to another illustrative and optional aspect, a filter (e.g., gaussian blur, box filter) is applied to the code prior to or after compositing the code with the video frame. By applying a filter, machine readability accuracy is increased.

According to another illustrative and optional aspect, each frame of the composited video is exposed to a neural network (NN). The NN learns based on the input video, the set of codes, and the composited video frames. The NN is able to produce improved compositing including, for example, step sizes for a feedback loop for finding a preferred, optimal or adequate level of luminance contrast relative to surrounding pixels in the composited video frames.

Other aspects, advantages, and features of the present disclosure will be apparent after review of the entire disclosure including the drawings and the claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The drawings, figures and pictures accompanying this application illustrate various features that serve as an additional basis for understanding the disclosure. In this disclosure, reference may be made to these visual depictions. The use of the same reference symbol in different drawings indicates similar or identical items.

FIG. 1 is an image having a visually unobtrusive scannable video code.

FIG. 2 is a close-up view of FIG. 1.

FIGS. 3, 5, 7, and 9 are images of a video with conventional QR codes.

FIGS. 4, 6, 8, and 10 are images of a video encoded with QR codes corresponding to FIGS. 3, 5, 7, and 9.

FIG. 11 is a diagram illustrating a system in which to activate a serialized visually unobtrusive scannable video code.

FIG. 12 is a diagram illustrating creation of a video having serialized visually unobtrusive scannable video codes.

FIG. 13 is a flowchart of a method illustrating activation of a serialized visually unobtrusive scannable video code.

FIG. 14 is a close-up view of area A of FIG. 11.

### DETAILED DESCRIPTION

There are few if any mechanisms for video consumers to respond in real time to particular conventional advertisements. Further, there are few if any mechanisms for viewers to obtain information about the scenes, products, actions and content of video at particular frames of the video—other than to perform a general search via a search engine. Searching through thousands of search results is often fruitless.

When an online advertisement for a video is presented on a user device, it typically takes the form of an opaque overlay of a static graphic or motion-based graphic on top of the video. These types of push advertisements are highly irritating and distracting to viewing of the video. A typical interaction with a user is for the user to briefly read the advertisement and to clear the overlay thereby missing a few seconds of the video content. These advertisements generally are not targeted to specific viewers, only to a particular (and likely) demographic. Further, these advertisements rarely include content that is up to the minute. Yet further, the advertisements are not based on an identification of the viewer. When there is interest in an online video advertisement, the advertisement is typically connected with a link. The user then clicks on the link of the advertisement. The online video content is paused and the user is presented with a Web page in a separate window.

Another form of conventional tool to reach viewers is a code (e.g., phone number, SMS number, website address, hashtag) that is either presented in a video or in an overlay accompanying the video. Rarely if ever is the code directly associated with the content of the video. Presenting the code is very obtrusive. A further drawback is that a user must take his or her eyes away from the video, obtain another device (e.g., mobile phone, laptop), and then enter the code. If the viewer cannot remember the code, the viewer misses an opportunity to obtain further information about the video or to otherwise interact with the content of the video.

A trend in video consumption is for viewers to interact with each other in real time as a video or live content is in being presented. For example, mobile device users often join social media sites like micro-blogging sites, and make and read posts in real time while simultaneously watching a same video in multiple locations. In this way, viewers can interact with others as part of an ad hoc community of realtime active participants.

What is needed is for content makers and providers to facilitate better and parallel means for viewers and participants to gain additional information in realtime about a particular video or event taking place. What is needed is a device, system, and method that is not highly obtrusive to others who wish to be more passive consumers. What is needed is a mechanism that can adapt in realtime, a device, system, and method that can be tailored to each participant and a parallel system and method for delivering content about a video or presentation. What is needed is a system for an enhanced informational stream that can be pushed to an additional device or screen.

Overview. Systems, devices and methods are described for providing parallel content for a video. Parallel content can take the form of text, video, audio or any other type of content. A database or collection of informational content is keyed to particular time segments of a video. An encoder generates links to the informational content. The links are encoded into a series of visible video codes. Each visible video code is adapted to a respective frame the video in terms of at least one of hue, transparency and position. The visible video code may be a QR code or other machine-readable code. A visible video code provides a link to metadata, informational content, secondary content or other content associated with or about the primary video in which the visible video code is presented. Content is served to a secondary screen based at least on the visible video code and, alternatively, based on additional information available from a secondary device used to scan and interpret the visible video code in the primary video. Such additional information may include a personal profile identifier or personal attribute associated with a user of the secondary device. Preferably, the visible video code is connected with particular video frames or video times of the primary video.

While a QR code is illustrated with respect to the figures, this type of code is just one example of many types of codes that may be used. The same technique described in reference to a QR code can be applied to other types of codes including both human-readable codes and machine-readable codes. It is possible to produce a graph that would be semi-transparent and yet still clearly visible to a human-eye. ISO/IEC 18004:2015 is one of the standards for QR codes and the official ISO/IEC 18004:2015 is incorporated by reference herein in its entirety.

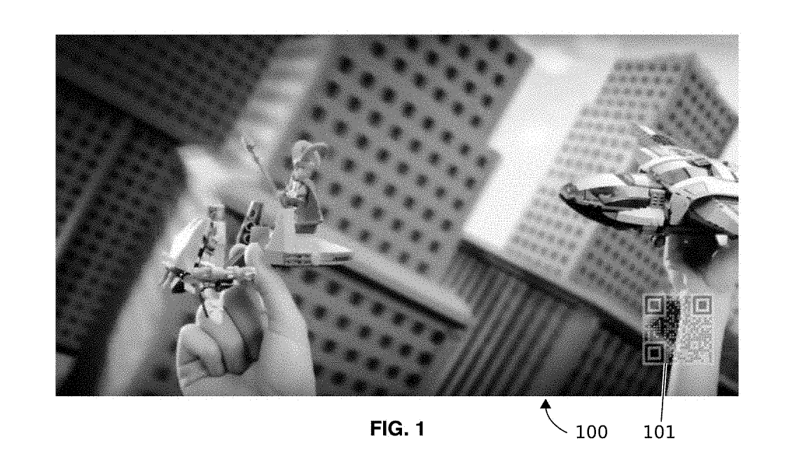

FIGS. 1-10 illustrate the use of QR codes to provide serializable non-obtrusive visible video codes. FIG. 1 is an image having a visually unobtrusive scannable video code. FIG. 1 is a (color) frame 100 of a video showing a visually unobtrusive QR code 101 as created by following the techniques described further herein. The QR code 101 is encoded with a link to additional content according to a first embodiment. For example, a link could be an HTTP-style link to an e-commerce Web page where a user could buy one or more products displayed in that particular frame or sequence of frames. In a specific example, the e-commerce site could offer the toys shown in the frame 100 and could even offer a time-sensitive discount or location specific discount based on where the video is being shown. That is, auxiliary information could be provided to a service provider by a scanner application operating on the device scanning the visually unobtrusive QR code 101.

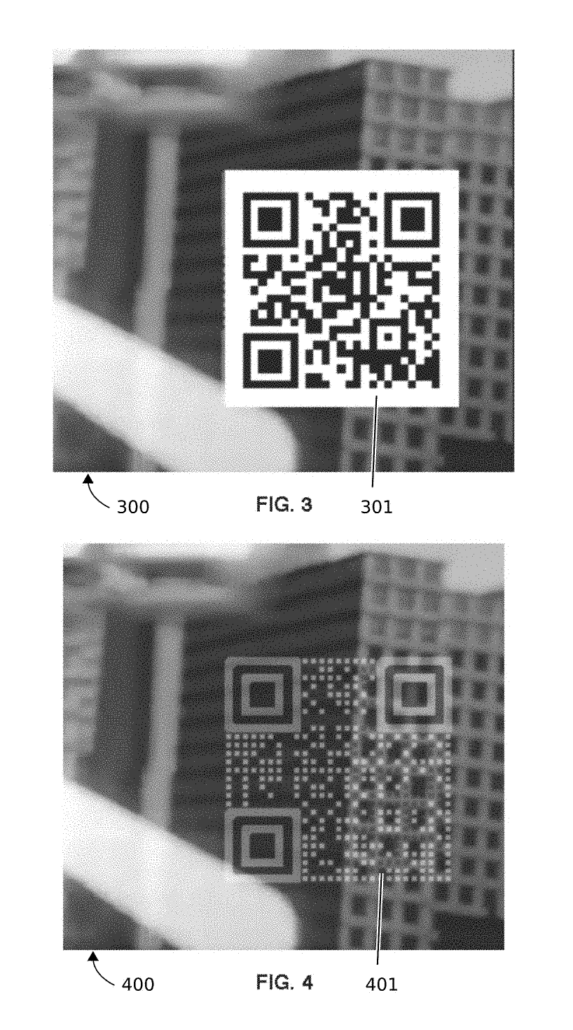

In FIG. 1, the QR code is shown in the bottom right corner of the screen. The visually unobtrusive QR code is distinct from a conventional QR code in at least three aspects. First, the QR code of FIG. 1 is semi-transparent and relatively non-obtrusive. (Examples of conventional, opaque and obtrusive QR codes are shown and described in relation to other figures including FIGS. 3, 5, 7, and 9, and are shown in contrast to the QR codes as modified by the instant techniques described herein.) Second, a content of the QR code of FIG. 1 includes a timestamp component that ties the content of the QR code 101 of FIG. 1 to the particular frame on a timeline of this particular video. Third, this QR code of FIG. 1 has been modified to this particular frame of video. Modification as used herein means at least picking one or more hues for an entirety of the QR code for the frame of video, and picking a transparency depending on a local or overall brightness of video frame in which the QR code is to appear. That is, it is possible to adjust at least two aspects of the QR code 101 with respect to each frame 100 and with respect to each sub-region of the frame 100 where the QR code 101 appears. The location of the QR code 101 may be moved to a different location in previous frames and in subsequent frames without losing the ability for a scanner to successfully scan the frame 100 and decode the QR code 101 almost instantly.

However, in a preferred embodiment, the QR code in FIG. 1 remains in a first location from frame to frame such as over a few seconds or over the entire video, especially for a particular sequence of images that do not change substantially from frame to frame. In other embodiments, the QR code is placed at different positions in the video frames over time as needed to reduce a subject or object measure of obtrusiveness of the QR code.

As illustrated in FIG. 1, an obtrusive, opaque QR code would obscure a substantial portion of the video. For example, for a frame that is substantially filled with a bust or face of a person, a conventional opaque QR code would cover a portion of the face. For a video that includes footage of a political debate, it would be highly obtrusive to place an opaque QR code over a face of a candidate. As shown in FIG. 1, a QR code 101 as generated and used herein would be nearly almost transparent to the naked eye and would be non-obtrusive to the viewing of the video. In the embodiment shown, the QR code 101 is visible. Other video codes, using the techniques described and shown herein, may be used to encode a video code that is not visible or noticeable to a substantial portion of ordinary human observers. Future developments can lead to use of other two-dimensional codes as would be understood to those of ordinary skill in the art. A QR code 101 as shown in FIG. 1 is just one example of many types of codes that may be so treated. Whether visible or invisible to a human, the video codes as generated herein are readable by a camera, mobile phone, computer, or other device. These codes bridge, through the use of a sensor such as a camera sensor, two computers or end points. One of those computers may be a service or server. In this instance of FIG. 1, the QR code 101 enables a second computer (not shown in FIG. 1) to detect and decode a video code (e.g., QR code) through a camera that scans the frame(s) of videos. FIG. 1 illustrates just one frame 101 of a sequence of frames of a video. Multiple QR codes such as the one QR code 101 shown in FIG. 1 is added to some or all of the other frames of video.

QR codes or video codes as described herein may be scanned and decoded by currently existing or yet-to-be developed devices. Currently, there are available a variety of portable personal computing devices, including wireless telephones such as mobile phones and smartphones, tablets, and laptop computers that are small, lightweight, and easily carried by users that can scan and decode the QR code 101 as shown in FIG. 1. These devices can communicate voice and data packets over wireless networks. Further, many such devices incorporate additional functionality such as a digital still camera, a digital video camera, a digital recorder, and an audio file player. Such devices can process executable instructions, including software applications, such as a Web browser application, that can be used to access the Internet. As such, these devices can include significant computing capabilities that can be used to capture and decode the QR code 101 as used herein.

Due to the limitations of space herein, only a few examples of application are provided. For example, in the context of a live broadcast of a political candidate debate, the techniques described herein can be used to generate and over-impose a graph of popularity of each candidate and plot the graph in real-time, getting the data from positive/negative data provided by a same or different source. For example, realtime viewers could scan a visually non-obtrusive code, which can then be used together in the aggregate to generate a graph of data from participants and viewers across a broadcast range of viewership and can do so in realtime. As a specific example, a realtime visible (and semi-transparent) graph could be added to a news video broadcast based on twitter comments about the particular event.

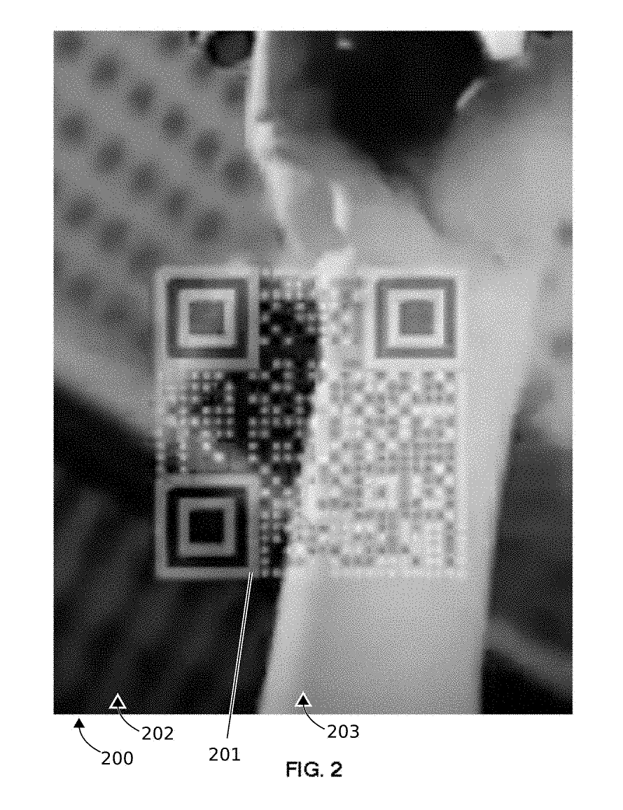

FIG. 2 illustrates a close-up view of the QR code shown in FIG. 1. In FIG. 2, the entire QR code 201 is shown in the portion 200 of the frame 100, and is perceived, as a single hue. The QR code 201 is semi-transparent. It is visible to both humans and machines. According to other embodiments (not shown) the QR code 201 may be truncated or used with a plurality of colors or hues, and different transparency values, across the QR code 201, and a decoder could scan the QR code 201 and use the inherent error correction available in the QR standard to still easily and properly decode the QR code 201. While not shown in FIG. 2, the use of multiple colors (e.g., 2, 3, 4, 5, 6) can be programmatically (automatically) added to the QR code 201 such as a first color for the QR code 301 in a first region 202 and a second color in a second region 203 to further reduce the obtrusive nature of the QR code. This process of adjusting the color(s) or hue(s) of the QR code 201 can be repeated for each frame or each index frame of a video. While the QR code 201 is shown at a single size, the QR code 201 could be enlarged or reduced over time (from frame-to-frame) in a video so as to yet further reduce the obtrusive nature of the QR code shown in the video, depending on the content and color of the video frame 100, 200 and based on the content of the frame of video from frame to frame.

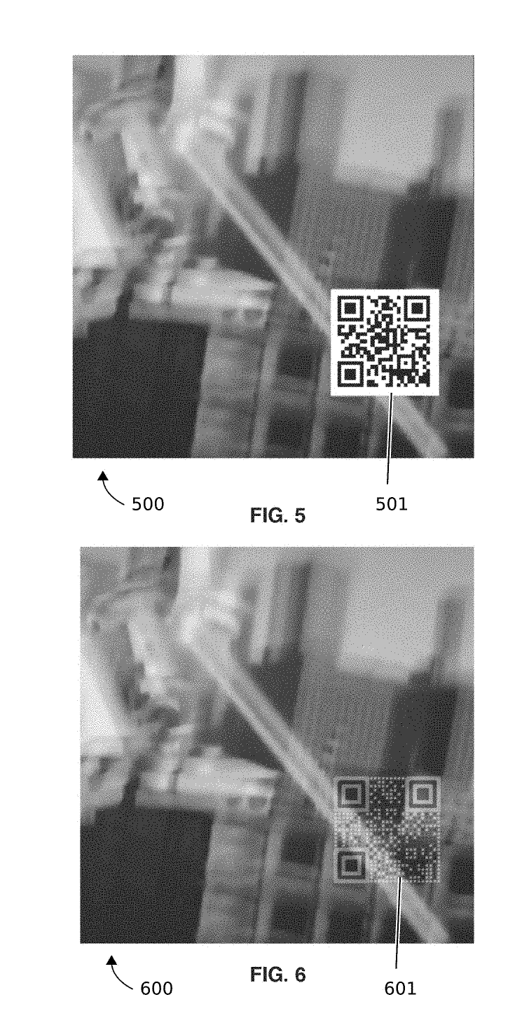

FIG. 3 illustrates a video frame bearing a conventional QR code. Such conventional QR code 301 covers substantial detail in the video frame 300. FIG. 4 shows the same data of the QR code encoded in a QR code 401 according to the techniques described herein where the QR code 401 of FIG. 4 is substantively reduced in obtrusiveness with respect to the frame 400. With reference to FIGS. 3 and 4, one or more of the hues of the QR code 401 in FIG. 4 have been altered based on the hues and/or colors of the underlying frame 400. And, the transparency value of the pixels of the QR code 401 in FIG. 4 have been altered to be as least obtrusive as possible with respect to the frame 400. Further before-and-after illustrates are presented in FIGS. 5-10.

FIG. 5 illustrates a video frame 500 bearing a conventional QR code 501. Such conventional QR code 501 covers substantial detail in the video frame 500. FIG. 6 shows the same data of the QR code encoded in a QR code 601 according to the techniques described herein where the QR code 601 of FIG. 6 is substantively reduced in obtrusiveness with respect to the frame 600. The frame 500, 600 of video in FIGS. 5 and 6 includes a city scape and a purple toy sword. The obtrusiveness of the convention QR code shown in FIG. 5 has been substantively reduced as shown in FIG. 6. With reference to FIGS. 5 and 6, one or more of the hues of the QR code 601 in FIG. 6 have been altered based on the hues and/or colors of the underlying frame 600. And, the transparency value of the pixels of the QR code 601 in FIG. 6 have been altered to be as least obtrusive as possible with respect to the frame 600.

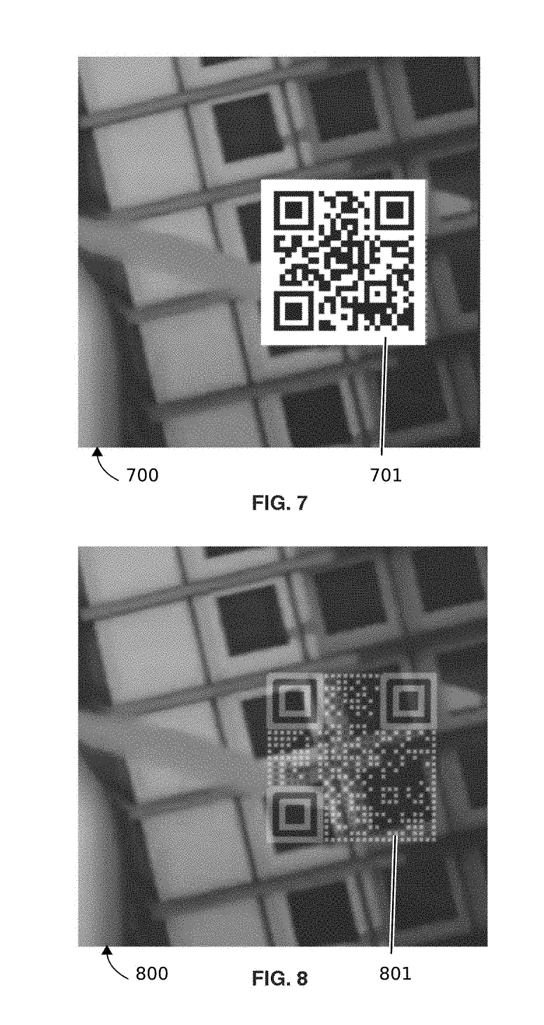

FIGS. 7 and 8 illustrate another before-and-after comparison of a frame of video that includes a QR code. FIG. 7 illustrates a video frame 700 bearing a conventional QR code 701. Such conventional QR code 701 covers substantial detail in the video frame 700. FIG. 8 shows the same data of the QR code encoded in a QR code 801 according to the techniques described herein where the QR code 801 of FIG. 8 is substantively reduced in obtrusiveness with respect to the frame 800. The frame 700, 800 of video in FIGS. 7 and 8 includes a city scape and a portion of a green toy sword. The obtrusiveness of the convention QR code shown in FIG. 7 has been substantively reduced as shown in FIG. 8. With reference to FIGS. 7 and 8, one or more of the hues of the QR code 801 in FIG. 8 have been altered based on the hues and/or colors of the underlying frame 600. One or more of the hues, the brightness, and the transparency of the QR code 801 appearance have been altered in FIG. 8 relative to the QR code 701 of FIG. 7. In practice, a QR scanner easily and successfully scans the QR code shown in FIG. 8.

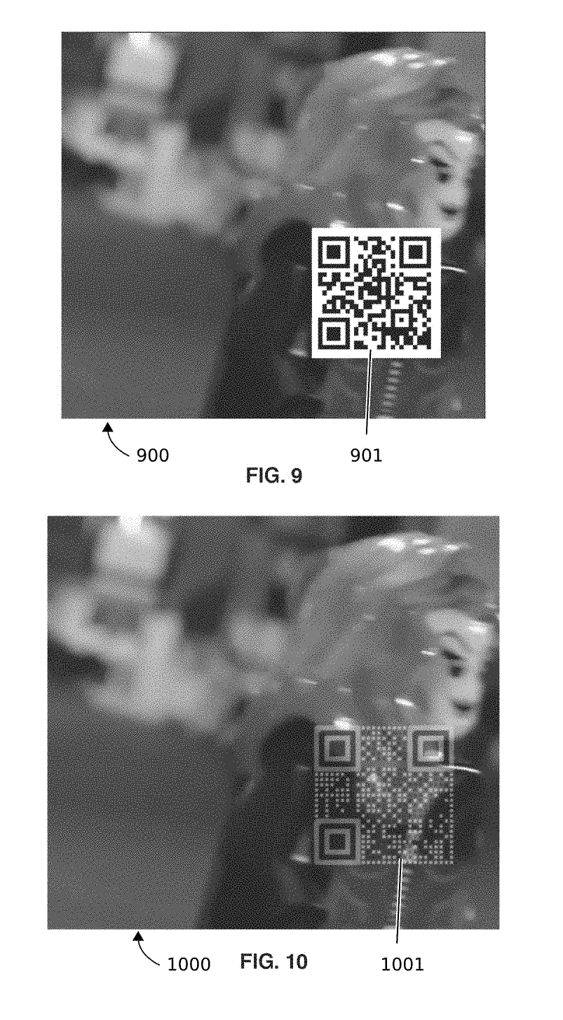

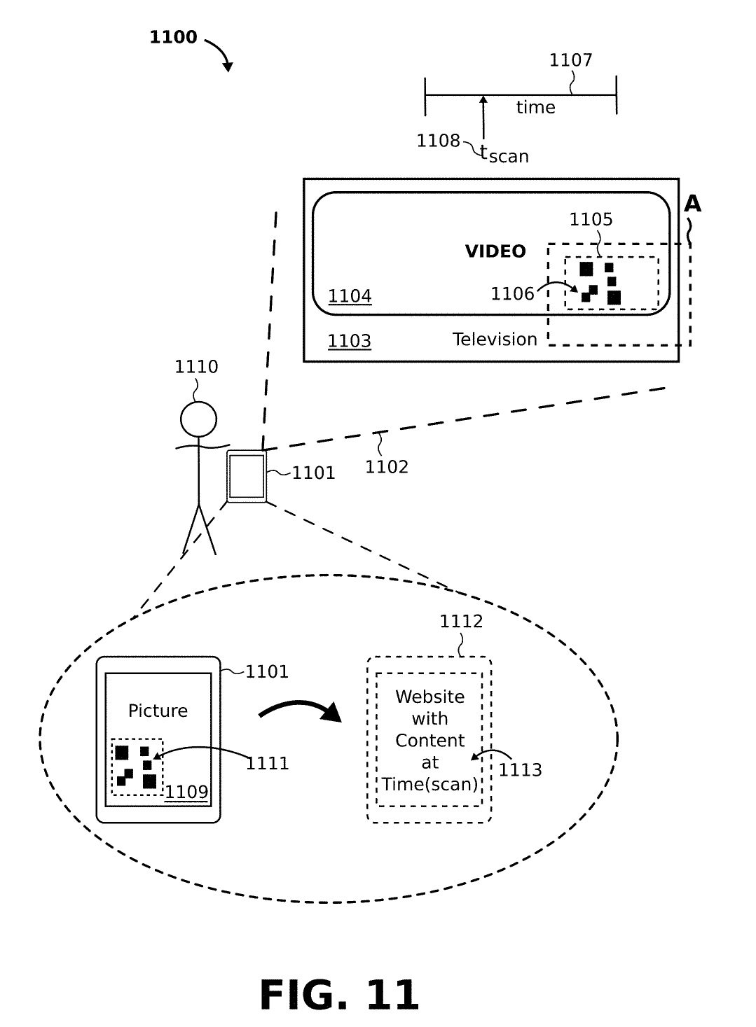

FIGS. 9 and 10 illustrate another before-and-after comparison of a frame of video that includes a QR code. The frame of video in FIGS. 9 and 10 includes a toy character with red hair with the QR code partially over the red hair. A QR code as shown in FIG. 9, if placed in all frames of a video segment of several seconds or minutes, would be highly obtrusive in terms of enjoyment of the video. FIG. 9 illustrates a video frame 900 bearing a conventional QR code 901. FIG. 10 shows the same data of the QR code encoded in a QR code 1001 according to the techniques described herein where the QR code 1001 of FIG. 10 is substantively reduced in obtrusiveness with respect to the frame 1000. The obtrusiveness of the convention QR code 901 shown in FIG. 9 has been substantively reduced as shown in FIG. 10. With reference to FIGS. 9 and 10, one or more of the hues of the QR code 1001 in FIG. 10 have been altered based on the hues and/or colors of the underlying frame 1000. One or more of the hues, the brightness, and the transparency of the QR code 1001 appearance have been altered in FIG. 10 relative to the QR code 901 of FIG. 9. In practice, a QR scanner easily and successfully scans the QR code shown in FIG. 10.

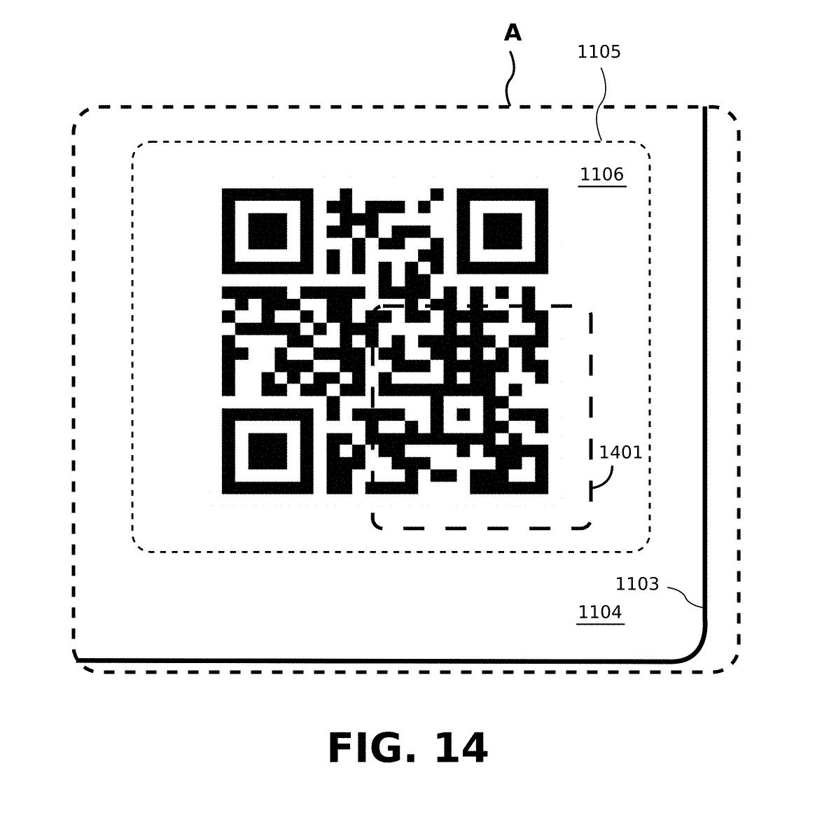

FIG. 11 is a diagram illustrating a system 1100 in which to activate a serialized visually unobtrusive scannable video code. FIG. 11 illustrates a viewer 1110 having a second device 1101 scanning a code-enhanced video 1104 being displayed on a first device 1103 such as a large television. The frame of reference visible to a camera of the second device 1101 is shown with field of view lines. The first inset illustrates a still image of a portion of the field of view of the camera—indicated as “A” which is shown in closeup view in FIG. 14.

In FIG. 11, in the first inset, a partial picture 1109 of the television is visible along with a representation of the code 1111. The original code 1106 is shown in the video 1104 in a region 1105 designated for a visual code. The region 1105 may remain in one location throughout the running of the video 1104 or may move around the screen of the first device 1103. The second device 1101 is able to identify and decode the QR code 1106 visible on the first device 1103. The QR code 1106 of FIG. 11 is like one of those shown at, for example, FIGS. 1, 2, 4, 6, 8, and 10. A curved arrow to a second inset 1112 indicates what is served by a server at a brief time after scanning the QR code 1106—the inset 1112 showing an example of a result of scanning the QR code 1106. In this example of FIG. 11, a Web page as content of a Website is served back to the second device 1101 in response to scanning the QR code 1106 at the particular frame of video on the display. The particular frame scanned is represented along a timeline 1107 of the video at t(scan) 1108. Although not illustrated, in FIG. 11 the second device 1101 has Internet or some type of network access. For example, the second device 1101 is a mobile phone and may have Internet in one of a plurality of ways including Wi-Fi provided to the house or via a mobile phone data service being available at the location of the second device 1101. The second device 1101 passes a content of the QR code 1106 to a server which then serves back the content as represented in the second inset 1112. The area A is shown in FIG. 14 and is further described in relation to that figure.

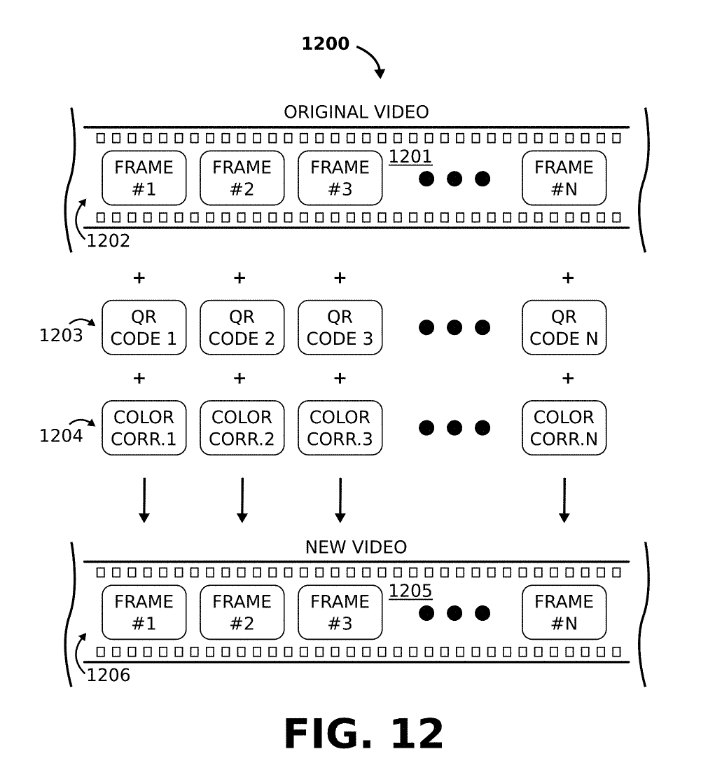

FIG. 12 is a diagram illustrating creation of a video having serialized visually unobtrusive scannable video codes. Using the method 1200 conceptually illustrated in FIG. 12 creates a QR code for frames of video as illustrated in a single frame of video shown in FIGS. 2, 4, 6, 8 and 10. A local device or a server or other hardware device or component may generate the QR codes and performs the steps shown.

In FIG. 12, a conventional (“original”) source video 1201 is shown. The original video 1201 includes frames 1-N represented by the series of frames 1202. At least some of the frames (e.g., key frames, I frames) of the video has been scanned and some data (e.g., hues or colors, brightness, size) have been identified or recorded. A QR code 1203 numbered 1-N has been generated for each of the frames 1-N. The QR codes 1-N are combined with a respective correction or adjustment such as indicated by the “color correction” 1-N shown in FIG. 12. While a color correction is shown in FIG. 12, this is merely a placeholder for one or more corrections or adjustments that can take place. For example, a hue, a brightness and a transparency of each frame 1202 and each QR code 1203 may be made at the respective correction 1204. According to the embodiment shown, a new video 1205 at the bottom of FIG. 12 is generated. The new video 1205 includes a sequence of frames 1-N that bear the QR codes 1203 and the enhancements or corrections 1204. This code-enhanced video 1205 is then ready for distribution and display. Some or all of the processing may be done at a first computer, or some of the steps may be done in realtime as the video is displayed or distributed. For example, some of the processing may be done as a video is being captured, while other steps may be performed in post-processing. That is, a hue correction, a color adjustment, a brightness, and a transparency may be stored separately or within the original video 1201 when the original video 1201 is captured by a video recorder. That way, subsequent QR codes 1203 and the corrections 1204 may be performed with less computer processing needed in order to get the QR codes embedded or encoded into the final new video 1205.

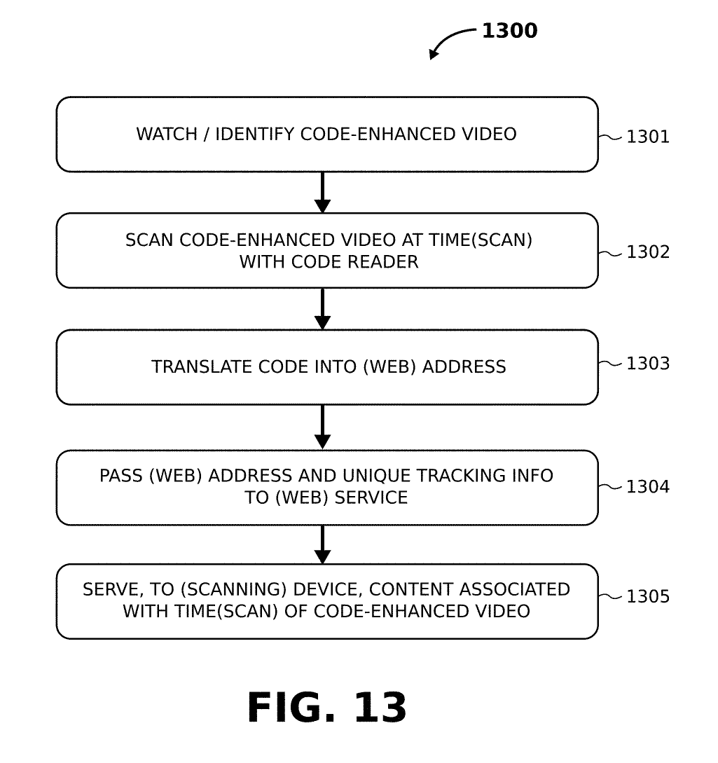

FIG. 13 is a flowchart of a method illustrating activation of a serialized visually unobtrusive scannable video code. FIG. 13 illustrates steps of using or consuming a QR code as used herein according to one embodiment. At step 1301, a viewer watching a code-enhanced video decides to interact with or inquire about a particular segment of video by identifying that the video is code-enhanced. A device displaying the video may perform the identification that the video being displayed is code-enhanced.

At step 1302, using a second device, the viewer scans the code-enhanced video at a scan time T with a code reader. If consuming a video on the second device, the scanning may be done by the viewer application itself without a need to activate a camera of the second device. At step 1303, the second device translates the QR code (or visible video code) into a Web address and, at step 1304, passes the Web address (and optionally other information available on or available to the second device such as tracking information) to a Web server at the address encoded in the QR code. At step 1305, the server (and allied components) serve content to the second device based on the encoded values and other information sent to the server. Those of ordinary skill would recognize that one or more of a variety of information available to the second device may be sent to the address of the server embedded in the visually enhanced QR code.

FIG. 14 is a close-up view of area A of FIG. 11—the close-up of the first device or large screen television 1103 displaying the code-enhanced video 1104. In FIG. 14, a non-visually-obtrusive QR code 1106 is illustrated in black and white such as one illustrated in color in FIGS. 1, 2, 4, 6, 8, and 10. Some or all of the QR code 1106 may change over time in any particular code-enhanced video, from frame to frame a same or a different code may be shown since it is embedded or encoded in the video being presented. According to a first embodiment, each frame of the video is encoded with a unique or semi-unique, non-visually-obtrusive QR code. According to other embodiments, a small series of frames is encoded with a same non-visually-obtrusive QR code.

In general, according to one or more embodiments, at least a portion of the QR codes as generated and used herein changes from frame to frame as indicated by the lower right region 1401 of the QR code 1106 that designates, by way of example, a pre-determined region of the QR code that is programmatically allowed to be changed for the benefit of encoding a sequence or set of addresses, time tags, and the like within the sequence or set of QR codes.

In FIG. 14, the QR code 1106 is found within a region 1105 designated for a visual code. For a QR code such as the QR code 1106 of FIG. 14, everything except the 3 large blocks and perhaps some small blocks can be changed or altered from frame to frame being a different QR code from frame to frame such as indicated in the changeable region 1401. Some or all of the anchor or orientation sections of the QR code may remain unchanged with respect to encoding of content of the QR code. According to one programmatic encoding scheme, the rest of the QR code is allowed to change drastically according to conventional QR encoding even with addition or substitution of even a single character. According to another example, QR code encoding is altered so as to minimize changes of the QR code based on a change to a key tied to each respective video frame, the key encoding a time within the video so that the particular QR code can be tied to a particular time of the video, a particular frame of the video.

Use of the QR code as described herein may require a modification to the colors of an underlying image or frame. For example, enhancing or changing one or more of the colors is performed. The colors or hues may be darker or lighter, depending on whether that part of the image that is used for the background for the QR code is dark or light. Each frame of the video is encoded following a similar pattern from frame to frame so that an observer sees little change as the QR code changes from frame to frame. At every specific time or interval of time, the QR code 1106 is dynamically changed such that not only a URL is encoded but also a timestamp parameter (e.g., time tag) corresponding to a time from a start time of the video.

A video which is encoded with this type of substantively transparent QR code becomes non-intrusive enough so that advertising and marketing companies are likely to consider putting this type of QR code into and onto media, especially dynamic media such as video, video clips, animated images and streaming content. As a result of use of QR codes having a timestamp keyed to frames or a time in the runtime of a video, media companies gain valuable analytics from those who scan the QR code with their smartphones or other type of secondary devices. The analytics include the timestamp of where the click-action took place relative to the start of the video. If a user opts in, data may be made available by a scanner application operative on the second device such that the analytics can also include a geographic location of the user who clicked (scanned) the QR code, and how many clicks the video received, both at the particular frames and at a particular time in realtime terms such as when any particular device scans the particular QR code of a particular frame of video. Other types of data sharable by the second device include device type, device model, device operating system, and the full range of data available from a smartphone as is known by those of ordinary skill in the art to share.

According to one illustrative embodiment, the QR code can be encoded in two parts: a first part that includes information about where to redirect, and an alpha-numeric digit following a “/” or other character as a divider. For example, the following can be used to encode a timestamp relative to the start of the video: 0-9, a-z and A-X for a total of 60 characters representing 1-60 seconds, minutes or hours. The QR encoding could be turned on or off if encoded into a DVD format similar to turning on subtitles or such as in the lower third or chyron formats and in those regions.

According to one example, a time is encoded according to the following scheme. A time in an HH:MM:SS format is encoded by minimizing a number of characters using this structure: 0-9 for the first 10 digits, a-z for the next 26 digits, and A-X for the next 24 digits—making the total 60 digits for each hour, minute, second and fractions of a second, respectively. Since most videos rarely run over 10 hours, an hour runtime is reduced to just a single digit of 0-9. So, by way of example, for a marker or runtime encoding for 1:23:11.5, the following encoding for the URL encoded in the QR code is the result: http://www.Website.com/path/1nb5. Other shortening schemes are possible.

Various illustrative components, blocks, configurations, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the aspects disclosed herein may be embodied directly in hardware, in a software module executed by a processor, or in a combination of the two. A software module may reside in random access memory (RAM), graphical processing unit (GPU), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of storage medium known in the art. An exemplary non-transitory (e.g. tangible) storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown and described herein but is to be accorded the widest scope possible consistent with the principles and novel features as defined by the following claims.

What is claimed is:

1. A system for providing parallel content for a video, the system comprising:
a database of informational content keyed to particular time segments of a video stream, wherein time segments include at least one frame of the video;
an encoder configured with instructions to generate links to the informational content;
a video code generator configured with instructions to encode links into a series of visible video codes and to adapt each visible video code into a respective frame the component; and
a video mixer that combines each visible video code with a respective frame of the video.

2. The system of claim 1, wherein each visible video code is comprised of a two dimensional raster based image and includes a time element for identifying a time in a runtime of the video, wherein adapting each visible video code includes modifying a transparency of each visible video code based on a brightness of at least one of three hue values of an underlying frame of the video.

3. The system of claim 2, wherein the transparency of each visible video code is at least 50% for each visible video code.

4. The system of claim 1, wherein the visible video code takes the form of a QR code.

5. The system of claim 1, wherein the visible video code takes the form of a machine-readable code having error correction built into the encoding.

6. The system of claim 1, wherein an area of the visible video code is directed to a region that is less than 22% of an area of the video.

7. A method comprising:
identifying a series of discrete information to be associated with a primary video;
creating a series of links corresponding to respective ones of the discrete information;
encoding each of the links into a visible machine-readable code;
adapting each visible machine-readable code to one or more frames of the primary video by adjusting at least one of a brightness value or a transparency value of each visible machine-readable code;
combining the visible machine-readable codes with the primary video by adding each visible machine-readable code to at least one frame of the primary video.

8. The method of claim 7, wherein a portion of the discrete information for one of the visible machine-readable codes is exposition about a corresponding frame of the primary video to which the particular visible machine-readable code is combined.

9. The method of claim 7, wherein the discrete information includes a survey.

10. The method of claim 7, wherein the discrete information includes a second video with content associated with the primary video, wherein the link connecting the second video with the primary video includes a timestamp that coordinates in time the second video with a time of the primary video such that the primary video may be viewed concurrently with the second video with a single soundtrack.

11. The method of claim 7, wherein each visible machine-readable code is one hue selected from hues of a frame of the primary video into which the respective visible machine-readable code is added.
